(19) United States
(12) Patent Application Publication
(10) Pub. No.: US 2026/0110290 A1
(43) Pub. Date: Apr. 23, 2026

(54) WINDMILL GENERATOR WITH LINEAR TO ROTARY ACTUATOR

(71) Applicant: Henry Investment Group LLC, Flower Mound, TX (US)

(72) Inventors: James David Henry, Flower Mound, TX (US); Issa Nael Abu-Hasnah, Richardson, TX (US); Michael Vincent Lingad, Dallas, TX (US); Caleb Nick Geddie, Lewisville, TX (US); Karim Rahim Rehmani, Carrollton, TX (US); Bobby Lee Collins, Aubrey, TX (US); Daniel James Wood, Garland, TX (US)

(73) Assignee: Henry Investment Group LLC, Flower Mound, TX (US)

(21) Appl. No.: 19/117,045

(22) PCT Filed: Sep. 29, 2023
(86) PCT No.: PCT/US2023/034222

§ 371 Date: Mar. 29, 2025

Related U.S. Application Data
(60) Provisional application No. 63/411,384, filed on Sep. 29, 2022.

(51) Int. Cl. F03D 15/10; F03D 7/02; F03D 9/11

(52) U.S. Cl. CPC F03D 15/10; F03D 7/0284; F03D 9/11; F05B 2260/403; F05B 2270/337

(57) ABSTRACT

A wind-based power generation system includes a windmill having a wheel assembly, a gearbox coupled to the wheel assembly and configured to convert rotational motion of the wheel assembly into a reciprocal motion, and a shaft coupled to the gearbox and driven in a reciprocal motion. The wind-based power generation system also includes a crank system comprising a linkage and a pitman arm, the linkage and pitman arm configured to convert the reciprocal motion of the shaft into a rotational motion that drive a generator to produce electric power that may be used or stored.

### CROSS-REFERENCE TO RELATED APPLICATIONS

This patent application claims priority from, and incorporates by reference the entire disclosure of, U.S. Provisional Application No. 63/411,384 filed on Sep. 29, 2022.

### TECHNICAL FIELD

The present disclosure relates generally to power generation and more particularly, but not by way of limitation, to wind-based power generation using a windmill with a linear to rotary actuator.

### BACKGROUND

This section provides background information to facilitate a better understanding of the various aspects of the disclosure. It should be understood that the statements in this section of this document are to be read in the is light, and not as admission of prior art.

Since 1888, Aermotor Windmill Company has designed and built 95% of all the windmills in America. FIG. 1 illustrates an example of an Aermotor windmill. Historically, these windmills were used for pumping water from wells. The design is very classic, and its aesthetics are very appealing to consumers. In contrast to these classic windmills, modem windmills are being deployed at a rapid rate to produce electricity. While these modem windmills are quite effective for power generation, they are not aesthetically appealing. As a result, many land owners do not want to implement them. Thus, it would be desirable to combine the aesthetics of the classic windmill design with the ability to produce electric power instead of pumping water.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

In some aspects, a wind-based power generation system includes a windmill having a wheel assembly; a gearbox coupled to the wheel assembly and configured to convert rotational motion of the wheel assembly into a reciprocal motion; and a shaft coupled to the gearbox and driven in a reciprocal motion. The wind-based power system includes a crank system comprising a linkage and a pitman arm, the linkage and pitman arm configured to convert the reciprocal motion of the shaft into a rotational motion.

In some aspects, the crank system further comprises a bracket arm configured to be coupled between the shaft and the linkage.

In some aspects, the wind-based power generation system includes a generator that is coupled to the pitman arm to transfer the rotational motion of the pitman arm to an input shaft of the generator. In some aspects, the generator is a three-phase AC generator. In some aspects, the generator is a DC generator.

In some aspects, the wind-based power generation system includes a battery that is electrically coupled to the generator and configured to store electrical power generated by the generator.

In some aspects, the wind-based power generation system includes a charge controller configured to control charging of the battery.

In some aspects, the wind-based power generation system includes a maximum power point tracker (MPPT) that is electrically coupled to the battery and a power grid and configured to supply power from the battery or the power grid to a load.

In some aspects, the wind-based power generation system includes an MPPT that is electrically coupled to the battery and a power grid and configured to supply power from the battery or the power grid to a load.

In some aspects, a method of generating wind-based power includes converting rotational motion from a wheel assembly of a windmill into a reciprocal motion; driving a shaft using the reciprocal motion; converting the reciprocal motion of the shaft into rotational motion; driving an input shaft of a generator using the converted rotational motion from the shaft; and generating electrical power via the generator.

In some aspects, the method includes storing the generated electrical power in a battery.

In some aspects, the method includes providing electrical power from the battery to a load.

In some aspects, the converting the reciprocal motion of the shaft into rotational motion comprises using a crank system. The crank system includes a bracket arm connected to the shaft; a linkage connected to the bracket arm; and a pitman arm connected to the linkage.

In some aspects, a wind-based power generation system includes a controller configured to control the storage and usage of electrical energy generated by a generator driven by wind; and logic, stored on non-transitory, computer-medium, that, upon execution by one or more processors, causes performance of operations including: responsive to a determination that a power grid is not supplying power to a load, discharging a battery to provide power to the load; and responsive to a determination that the power grid is supplying power to the load, further determining if it is within a peak time and supply power to the load from the battery if it is within a peak power time.

In some aspects, the logic is further configured to limit charging of the battery to 90% of a maximum capacity of the battery.

In some aspects, the logic is further configured to limit discharging of the battery to 10% of a minimum capacity of the battery.

In some aspects, the logic is further configured to monitor a charge status of the battery to maintain the battery at 90% of a maximum capacity of the battery outside of a peak power time.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1 illustrates an example of a classic windmill design;

FIG. 2 is a system diagram for a wind-based power generation system, according to aspects of the disclosure:

FIG. 3 is an exploded assembly of a crank system for a wind-based power generation system, according to aspects of the disclosure:

FIG. 4 is a system diagram illustrating a wind-based power generation system, according to aspects of the disclosure;

FIG. 5 illustrates a method of operating a wind-based power generation system, according to aspects of the disclosure; and

FIG. 6 illustrates an example of a computer system operable to control a wind-based power generation system, according to aspects of the disclosure.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described. Reference will now be made to more specific embodiments of the present disclosure and data that provides support for such embodiments. However, it should be noted that the disclosure below is for illustrative purposes only and is not intended to limit the scope of the claimed subject matter in any way.

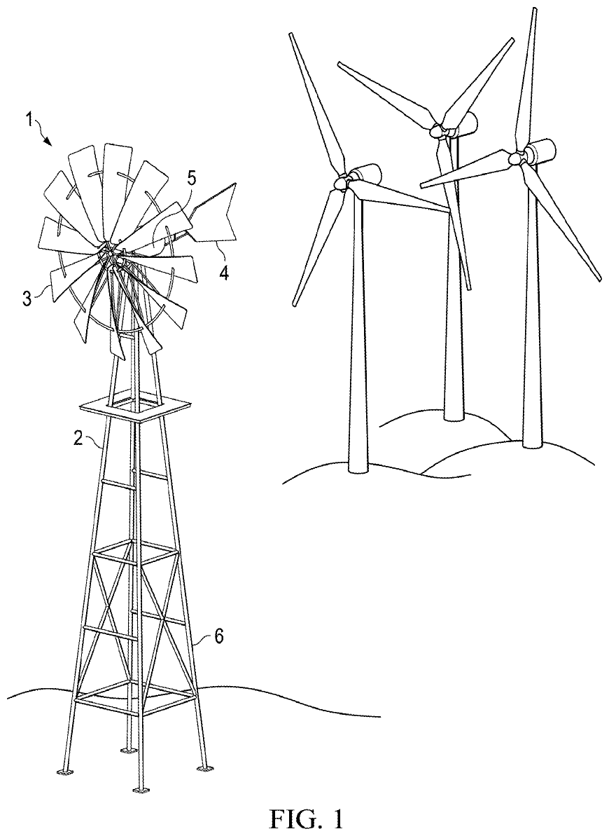

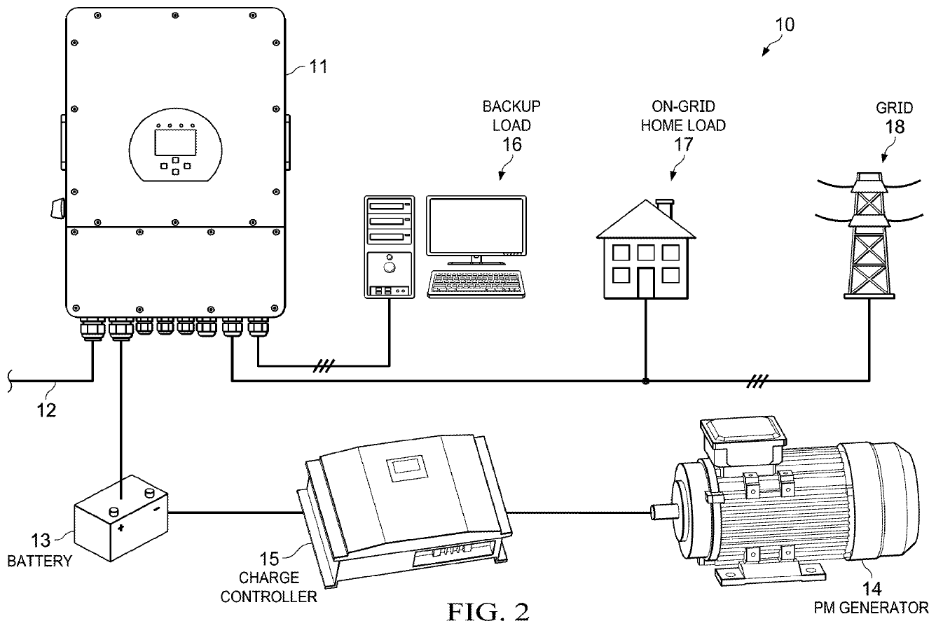

FIG. 2 is a system diagram for a wind-based power generation system 10, according to aspects of the disclosure. System 10 is meant to be integrated with a windmill, such as a windmill 1 illustrated in FIG. 1. Windmill 1 is in the style of the classic Aermotor windmills and includes a tower 2 that supports a wheel assembly 3 and a tail assembly 4. Wheel assembly 3 includes a plurality of blades that, in the presence of wind, rotate. This rotational motion is transferred by a shaft to a gearbox 5. Tail assembly 4 helps orient wheel assembly 3 to face the direction of wind. Gearbox 5 converts the rotational motion of wheel assembly 3 into a reciprocal motion that is transferred into a shaft 6. The reciprocal motion of shaft 6 is used to pump water from the ground. For water pumping, this operation has proven to be very reliable. The wind-based power generation systems of the instant disclosure are designed to convert the classic windmill that was designed for pumping water into an electric-power generation system.

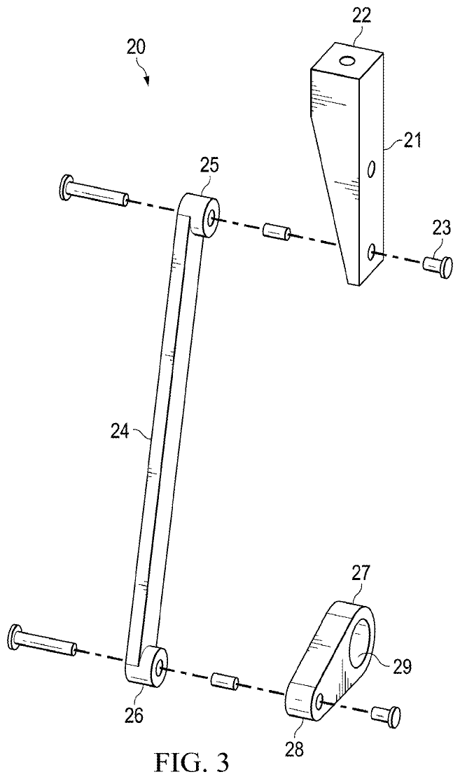

The wind-based power generation systems disclosed herein are designed to work with windmills having around an 8′ diameter wheel assembly, but it will be appreciated that the scale of the system can be altered. The aesthetic look of the windmill remains the same, but the reciprocal pumping motion of shaft 6 is converted back into rotational motion by a crank system (see FIG. 3). This rotational motion is coupled to a generator 14 (e.g., a three-phase AC generator) for electric power generation. Generator 14 may be a low RPM generator that produces three-phase AC, which generates about 500 Watts of power per hour in 20 mile per hour (mph) winds. A charge controller 15 rectifies the three-phase AC to DC to charge a battery 13. Charge controller 15 may also be used to increase the voltage supplied by generator 14. Generator 14 may be positioned at the bottom of the windmill to limit detracting from the classic aesthetic.

In some aspects, battery 13 is a lithium iron phosphate battery rated at 48V with 9.3 kW storage space. In other aspects, the type of battery, the amount of storage space, and the voltage rating may be altered. In some aspects, battery 13 includes 50 groups wired in parallel, with each group having 15, 3.2-volt battery cells wired in series to create 48 volts per group. The 50 groups together hold 9.3 kilowatts of power.

Controller 15 is a hybrid phase system with 48 Volts of output power to battery 13, 220-240 Volts at 60 Hertz of output power to the load, and a total rated power of 5 kW. Controller 15 is configured to work with an application that allows a user to manage and control system 10.

While the windmill turns, battery 13 is charged to store electrical energy that may be used to power a load 17 (e.g., a home) and the like. In situations where AC power is desired, controller 15 may be used to invert the current from DC to AC, and a fixed voltage of 220-240 volts may be output. Before this live wire can connect to a standard American outlet (requiring 120V), a Maximum Power Point Tracker (MPPT) 11 is used that includes a 1:1 center-tapped transformer, which allows the 220-240 volts to be separated into two 110-120 live wires. These live wires are connected to a breaker box, and one live wire is connected to an outlet. This solution converts pumping motion into rotational energy and produces 3 phase AC power, which is rectified to DC power to charge a battery, and then inverted back into AC power and sent into a transformer to produce the adequate voltage necessary to power a home.

In some aspects, system 10 has the capacity to discharge for 5 hours. During times when the battery 13 is charging, a power grid 18 will power load 17. However, once battery 13 is at the allotted maximum capacity, system 10 disconnects power from power grid 18, and load 17 is powered at a much cheaper cost by the energy stored in battery 13. Controller 15 eliminates the possibility of charging the battery for too long and controls how much battery 13 can discharge. This eliminates the risk of damaging battery 13 efficiently provide power to load 17.

Various modifications may be made to system 10, depending on the operational needs. In some aspects, controller 15 may be replaced with a controller that is configured for 120V outlets. This eliminates the need to modify the 220-240V output. In some aspects, the AC generator 14 and controller 15 may be replaced with a DC generator. This allows the DC generator to be directly connected to battery 13 for charging.

Table 1 below details horsepower of a windmill at a certain wind speeds, illustrating the amount of potential power generation that is available from system 10.

TABLE 1
Horsepower to kilowatt Conversion Total Horsepower

| Diameter | Wind Speed (right) | | | | |
|---|---|---|---|---|---|
| (Below) | 10 mph. | 15 mph. | 20 mph. | 30 mph. | 40 mph. |
| 6 ft. | 0.048 | 0.16 | 0.38 | 1.32 | 3.13 |
| 8 ft. | 0.08 | 0.28 | 0.69 | 2.35 | 5.57 |
| 10 ft. | 0.13 | 0.45 | 1.07 | 3.67 | 8.71 |
| 12 ft. | 0.195 | 0.65 | 1.55 | 5.28 | 12.55 |
| 14 ft. | 0.295 | 0.88 | 2.11 | 7.19 | 17.07 |
| 16 ft. | 0.34 | 1.15 | 2.76 | 9.39 | 22.30 |

Total Power Gen (kW)

| | | | | | |
|---|---|---|---|---|---|
| 6 ft. | 0.048 | 0.16 | 0.38 | 1.32 | 3.13 |
| 8 ft. | 0.08 | 0.28 | 0.69 | 2.35 | 5.57 |
| 10 ft. | 0.13 | 0.45 | 1.07 | 3.67 | 8.71 |
| 12 ft. | 0.195 | 0.65 | 1.55 | 5.28 | 12.55 |
| 14 ft. | 0.295 | 0.88 | 2.11 | 7.19 | 17.07 |
| 16 ft. | 0.34 | 1.15 | 2.76 | 9.39 | 22.30 |

Referring now to FIG. 3, an exploded assembly of a crank system 20 for a wind-based power generation system is shown, according to aspects of the disclosure. System 20 is configured to work with a conventional windmill design and converts the reciprocal motion of shaft 6 into rotational motion that is used to crank generator 14 to generate electrical power. System 20 is also configured to work with a swivel of water-pumping windmills to allow wheel assembly 3 to move 360 degrees to catch the wind. System 20 includes a bracket arm 21 that is configured to be coupled to shaft 6. Bracket arm 21 is coupled to a first end 25 of a linkage 24 via pinned connection. A second end 26 of linkage 24 is coupled to a first end 28 of a pitman arm 27 via a pinned connection. Pitman arm 27 is configured to be coupled to an input shaft of generator 14. For example, pitman arm 27 may include a bore 29 that is configured to receive the input shaft of generator 14.

During operation, shaft 6 is driven in a reciprocal motion by wheel assembly 3. Bracket arm 21, which is coupled to a lower end of shaft 6, also moves in a reciprocal motion. Linkage 24 interacts with pitman arm 27 to impart a rotational motion upon pitman arm 27 about a central axis passing through bore 29. Pitman arm 27 is coupled to generator 14 to turn the input shaft of generator 14 to generate electricity. In some aspects, the input shaft may be directly coupled to bore 29. In some aspects, a gearbox may be used increase or decrease the input speed to generator 14. In some aspects, using a longer pitman arm, setting up a mass-spring damper system, and running conduit along the windmill to protect the wires improves the functionality of system 10.

System 20 provides numerous benefits, including: generator 14 is easily wired; the aesthetics of the windmill are barely altered; the design of the system readily accommodates AC or DC generators; no changes to the overall structure of the windmill are necessary.

### WORKING EXAMPLE

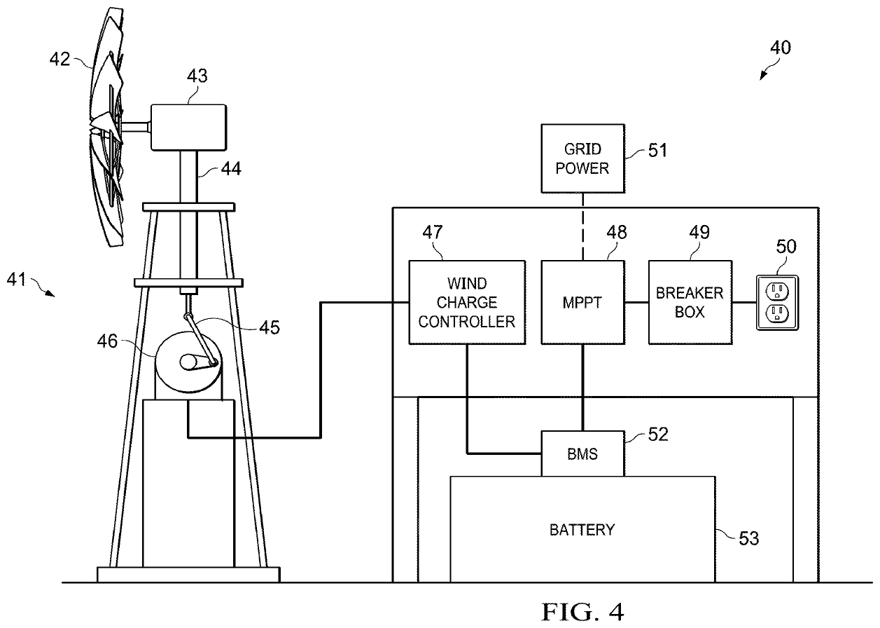

FIG. 4 is a system diagram illustrating a wind-based power generation system 40, according to aspects of the disclosure. System 40 includes a windmill 41 and a power generation system. Windmill 41 includes a wheel assembly 42, a gearbox 43, a shaft 44, a crank system 45 (similar to crank system 20), and an AC generator 46. As wheel assembly 42 turns, gearbox 43 converts the rotational motion of wheel assembly 42 into reciprocal motion that is imparted to shaft 44. Crank system 45 converts the reciprocal motion of shaft 44 back into rotational motion that can be input into AC generator 46. AC generator 46 is electrically coupled to a charge controller 47. Charge controller 47 rectifies AC power to DC power for charging of battery 53 at desired power outputs. Battery 53 is electrically coupled to a Battery Management System (BMS) 52, which balances battery 53 and controls an ability of an MPPT 48 to draw power from battery 53. BMS 52 is electrically coupled to MPPT 48. MPPT 48 draws power from battery 53 and inverts it from DC to AC to power a load 50. System 40 may also be connected to a power grid 51 to provide power when battery 53 is unable to otherwise power load 50. MPPT 48 selectively controls whether power is supplied to the load via power grid 51 or battery 53. In some aspects. MPPT 48 can be configured to act as the charge controller and charge controller 47 may be omitted. In some aspects, system 40 can additionally include one or more solar panels that may also be used to provide power to battery 53. In these aspects, MPPT 48 is configured to supply power to the load from one or more of generator 46, grid 51, and/or the one or more solar panels.

In various aspects, generator 46 is placed on a platform below gearbox 43 as shown in FIG. 4. When operating in wind speeds of 20 mph, generator 46 operates at about 32 RPM, which translates to about 500 W of power. This power is three-phase and travels along a length of wire (e.g., about 25 feet of wire) into charge controller 47. Charge controller 47 is typically located at the bottom of the windmill tower next to battery 53. As previously discussed, charge controller 47 prevents battery 53 from being supplied with too much power. Additionally, charge controller 47 acts as a ground when battery 53 has sufficient charge.

### MPPT Design

MPPT 48 is a split phase/hybrid MPPT that has a rated power of 5 kW. MPPT 48 is configured to receive 48V from battery 53 and 220-240V to the load with a frequency of 60 hz. It has a built-in communication interface and comes with an LCD screen that shows information such as AC data, battery mode, overload alarm, output voltage, output frequency, and the like. MPPT 48 includes a user interface that allows users to monitor the system using a mobile application (e.g., via mobile device). Information available in the application includes the operation MPPT 48 is currently taking, charts that show monthly power generation, and data detailing current, voltage, and power generated.

MPPT 48 is compatible with any kind of battery, and it has an efficiency rating of about 94%. System 40 is configured to use a single MPPT 48. A single MPPT is easier to control and reduces the amount of space needed to set system 40 up. In other aspects, multiple MPPTs may be used. MPPT 48 is beneficial in that it maximizes the power available. MPPT 48 also enables multiple operations to be performed when it comes to power allocation.

### Charge Controller

Because MPPT 48 will not accept three-phase AC as a direct input, generator 46 is connected to battery 53 through charge controller 47. Charger controller 47 enables generator 46 to connect to battery 53 by converting three-phase AC to DC using its built-in rectifier. In addition, charge controller 47 protects battery 53 by making sure that it doesn't overcharge using a built-in dump-load (i.e., power is sent to ground once battery 53 is full). Charge controller 47 has a voltage range of 40-60V DC, converts three-phase AC to DC at 150A maximum, and has a maximum rated power of 9600 W.

### Generator

Generator 46 is designed with operating parameters of, for example. Aermotor windmills in mind. For example, generator 46 is selected to be able to produce power at 32 RPM (a speed obtainable from the windmill during standard operating conditions). Additionally, it is known that the rotor blade angular speed with 20 MPH winds is 105 RPM and will generate 500 Watts of power. The windmill is able to work at about 32 strokes per minute of shaft 44. Those 32 strokes per minute will translate into 32 RPM output at crank system 45. As shown in Equation (1) below, the power is the product of torque (τ) and angular velocity (ω):

$$P = τ•ω \qquad Equation ( 1 )$$

Using Equation 1, power is given to be 0.5 kW with angular velocity to be 30 RPM. Solving for torque reveals to reach an optimal 0.5 kW, there needs to be 149.2 N·m of torque.

Knowing this information, system 40 was optimized for conditions of around 20 mph. Table 2 illustrates exemplary specifications generator 46.

TABLE 2
Generator Specifications for 20 mph wind conditions

| Generator Specifications | | |
|---|---|---|
| Rated Power | 2 | kW |
| Rated Rotation Speed | 118 | RPM |
| Rated Voltage | 48 V 3-Phase AC | |
| Rated Current | 24 | A |
| Starting Torque | 4.5 | N · m |
| Rated Torque | 164 | N · m |

| | |
|---|---|
| Efficiency | 95% |

Generator 46 is horizontally mounted just below the top of the windmill on a platform. An input shaft of generator 46 is connected to a gearbox that will be described in a later section. Another major consideration to think about is how the generator will be creating power whilst not operating at its rated specifications. Generator 46 has a linear power curve when it comes to RPM vs. power. This allows for easy prediction of power generation and allows the generator to operate at slower wind speeds. The power curve shows us that the generator has been tested to generate higher amounts of power at higher RPM which means that there is a factor of safety built into the design and that our design can exceed 20 MPH wind speed.

### Battery

Battery 53 is a 48-volt battery with a capacity of about 9,339 Watts. Battery 53 uses a plurality of 3.2 Volt single cell Lithium-Iron Phosphate batteries, which have a capacity of 3.8 Amp/Hour. Lithium-Iron Phosphate was chosen as it offers a greater life cycle at about an average of 2,000 more cycles compared to other battery options. It can withstand extreme temperatures from as high as 60 degrees Celsius to as low as −20 degrees Celsius. They are lightweight and compact which makes it easier to store and hide. To reach a 48-volt capacity, 16 single cell batteries are configured in series. When connecting batteries in series, the voltage will rise, and the capacity of the amp-hours will remain the same. To connect the battery cells in series, the positive terminal of one cell is connected to the negative terminal of the next cell. Connecting a quantity of 16 single cell batteries in series increases voltage to 48 volts and keeps the amp-hours at 3.8. When connecting batteries in parallel, the voltage will remain the same and the capacity of the amp-hours will rise. In order to connect batteries in parallel, the positive end of is connected to the positive end of another and the negative end of one to the negative end of the other. A quantity of 50 single cell batteries are connected in parallel, forming a battery bank. Each battery bank will have only 3.2 volts and 608 watt/hours. Battery 53 includes 16 banks connected in series, resulting in 48 volts and 9,339 watt/hours. This amount of charge capacity is selected to provide the estimated amount of power needed for 5 hours of peak usage.

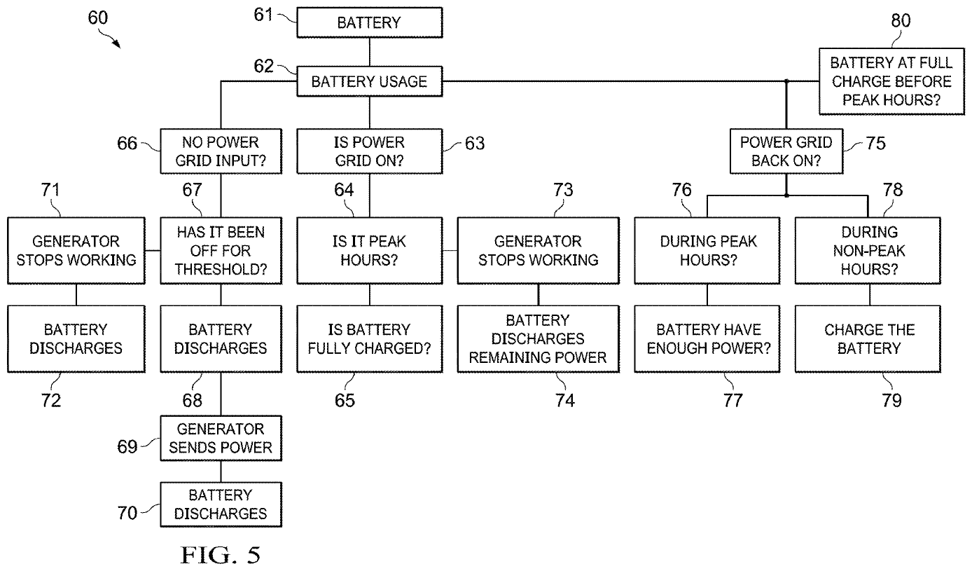

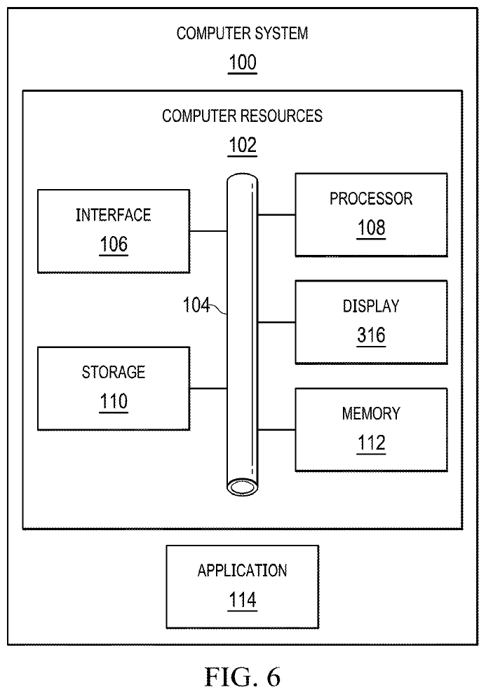

FIG. 5 illustrates a method 60 of operating a wind-based power generation system (such as systems 10, 40 discussed above), according to aspects of the disclosure. Method 60 may be carried out by one or more processors associated with a charge controller, an MPPT, or a dedicated controller. FIG. 6 and the related discussion below detail a computer system 100 that can be incorporated into one or more of a charge controller, an MPPT, or a dedicated controller and configured to carry method 60. Method 60 begins at step 61. At step 61, a battery of the system (e.g., battery 13, 53 discussed above) is set to discharge for a designated time period, e.g., from 3 PM-8 PM for a total of 5 hours at a high end of 2 k Watts/hour. The power grid will ideally power the house at all hours of the day except from 3 PM-8 PM, and the MPPT will not accept power from the power grid during those times. At step 62, the battery provides power. In an exemplary aspect, the battery may be held at a charge that is about 90% of its capacity and is allowed to discharge to about 10% of its capacity. Discharging the battery in this manner helps extend the performance life of the battery. The discharge of the battery varies based upon the status of the power grid. Step 63 and the steps that follow describe how the battery discharges if the power grid is on. Step 66 and the steps that follow describe how the battery discharges if the power grid is off. Step 75 and the steps that follow describe how the battery discharges once the power grid comes back on after being off. Step 80 does a check of the battery charge level to track whether or not the battery is at full charge prior to peak hours. If the battery reaches full charge before peak hours, the charge controller will send excess power created from the generator to ground (dump load).

At step 63, a determination is made if the power grid is on. If the power grid is on, a determination is made at step 64 if it is currently during peak hours. Peak hours may be defined based upon various factors, such as peak power demand for a region, or based upon time of day. If it is during peak hours, the battery will discharge at step 65 and the charge controller will have the generator send power through the battery to the load. If it is not during peak hours, the generator is shut down at step 73, and the battery discharges its available power at step 74. At step 74, the battery will discharge all remaining power to the house during peak hours, and then the MPPT will take power from the grid and send it to the load once the battery has reached 10% capacity.

At step 66, a determination is made if the power grid is off. At step 67, a determination is made if the power grid has been off within a threshold amount of time. The threshold amount of time can be, for example, within the last 24 hours. If the power grid has not been off within the threshold amount of time, then the method proceeds to step 71. At step 71, the generator turns off. At step 72, the battery discharges until it reaches 10% capacity to provide power. The charge controller will send power through the battery at a rate of 500 Watts/hour. If the power grid has been off within the threshold amount of time, then the method proceeds to step 68. At step 68, the battery discharges to provide power. At step 69, the generator is activated to send power through the charge controller and begin charging the battery until the battery reaches 50%. At step 70, the battery discharges until it reaches 10% capacity to provide power.

If it is determined that the power grid had been off, but has come back online, the method proceeds to step 75. From step 75, if the time is during peak hours, the method proceeds to step 76. At step 77, if the battery does not have enough power during peak hours, the battery will discharge until it reaches 10% capacity. The battery will then begin recharging until it reaches 90%. During this time, the power grid will provide power. From step 75, if the time is not during peak hours, the method proceeds to step 78. At step 79, the battery will be charged until it reaches 90% capacity to be ready to discharge during peak hours. The charge controller will send power through the battery to the load.

### Fabrication Process:

The crank handle's hole centers should be half the stroke length of the windmill's pump rod which was 7.688 inches for the test stroke length. The pitman arm minimum length is 14.851 inches which gives a 15-degree kick from the center of the pump rod. However, the pitman arm can be any length greater than the minimum so that the generator could be placed lower to get a better fit between the legs of the windmill.

### CONCLUSIONS

The pitman arm and crank handle system was designed to take the linear motion of the pump and translate it into rotational motion to turn a generator shaft using custom machined parts. A custom generator was designed to generate 500 Watts at 32 RPM and 2000 Watts at 118 RPM to gain power at different wind speeds. A charge controller was configured to be compatible with the generator and to rectify the three-phase AC into DC to charge the battery. The battery was created using 768 individual 3.2V Lithium-Iron Phosphate cells, nickel strip, and copper wire. It is a 48V, 9.3 kW battery designed to store excess energy generated by the windmill. The MPPT draws power from both the grid and the battery and sends it to the house. It is a smart system and will only draw from the battery until it is at 10% and then will switch to the grid to power the house. A step-down transformer was used to step the 220V-240V to 110V-120V to power the electrical outlet we are using to show power is working. The power generated is enough to power a house for several hours and serve as an emergency generator.

An alternative design for the entire system that we can recommend is having an MPPT that takes two DC inputs (an unstabilized DC generator and a stabilized solar panel), a standardized battery input, and a grid input with an output to the house

Another alternative design for the system is using an MPPT that has a built-in rectifier which would allow for a three-phase AC generator to work and eliminate the need for a wind charge controller. The MPPT would have inputs for the grid, the battery, a three-phase generator, and outputs to house and battery.

Another alternative design for the system is using a system with a DC generator that charges the battery directly with no rectifier. In this system, the MPPT will have inputs for the grid and the battery and an output for the house.

Another alternative design incorporates a mass-spring-damper system to minimize the vibrations of the generator as it is constantly being pushed down and then up by the pumping motion. Bolts are considered springs with a very high spring constant and a sturdy mat can be put under the generator as a damper.

FIG. 6 illustrates an example of a computer system 100 that, in some cases, can be representative, for example, of a computer and control system for wind-based power generation system. Computer system 100 includes an application 114 operable to execute on computer resources 102. Application 114 can be, for example, an interface for operating computer system 100. In other embodiments, application 114 can be, for example, an interface for operating and/or accessing all engines and datastores of computer system 100. In particular embodiments, computer system 100 may perform one or more steps of one or more methods described or illustrated herein. In particular embodiments, one or more computer systems may provide functionality described or illustrated herein. In particular embodiments, encoded software running on one or more computer systems may perform one or more steps of one or more methods described or illustrated herein or provide functionality described or illustrated herein.

The components of computer system 100 may comprise any suitable physical form, configuration, number, type and/or layout. As an example, and not by way of limitation, computer system 100 may comprise an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a wearable or body-borne computer, a server, or a combination of two or more of these. Where appropriate, computer system 100 may include one or more computer systems; be unitary or distributed; span multiple locations; span multiple machines; or reside in a cloud, which may include one or more cloud components in one or more networks.

In the depicted embodiment, computer system 100 includes a processor 108, memory 112, storage 110, a display 116, interface 106, and bus 104. Although a particular computer system is depicted having a particular number of particular components in a particular arrangement, this disclosure contemplates any suitable computer system having any suitable number of any suitable components in any suitable arrangement.

Processor 108 may be a microprocessor, controller, or any other suitable computing device, resource, or combination of hardware, software and/or encoded logic operable to execute, either alone or in conjunction with other components. (e.g., memory 112), the application 114. Such functionality may include providing various features discussed herein. In particular embodiments, processor 108 may include hardware for executing instructions, such as those making up the application 114. As an example, and not by way of limitation, to execute instructions, processor 108 may retrieve (or fetch) instructions from an internal register, an internal cache, memory 112, or storage 110; decode and execute them; and then write one or more results to an internal register, an internal cache, memory 112, or storage 110. Display 116 is configured to display information to a user (e.g., route guidance information). In some aspects, display 116 may be a touchscreen display that receives input from a user (e.g., origin and our destination information). In some aspects, display 116 may be integrated into computer system 100 (i.e., when computer system 100 is a mobile, stand-alone unit). In some aspects, display 116 may be integrated into a vehicle (i.e., a part of the infotainment and/or navigation system of an automobile in which computer system 100 is installed).

In particular embodiments, processor 108 may include one or more internal caches for data, instructions, or addresses. This disclosure contemplates processor 108 including any suitable number of any suitable internal caches, where appropriate. As an example, and not by way of limitation, processor 108 may include one or more instruction caches, one or more data caches, and one or more translation lookaside buffers (TLBs). Instructions in the instruction caches may be copies of instructions in memory 112 or storage 110 and the instruction caches may speed up retrieval of those instructions by processor 108. Data in the data caches may be copies of data in memory 112 or storage 110 for instructions executing at processor 108 to operate on; the results of previous instructions executed at processor 108 for access by subsequent instructions executing at processor 108, or for writing to memory 112, or storage 110; or other suitable data. The data caches may speed up read or write operations by processor 108. The TLBs may speed up virtual-address translations for processor 108. In particular embodiments, processor 108 may include one or more internal registers for data, instructions, or addresses. Depending on the embodiment, processor 108 may include any suitable number of any suitable internal registers, where appropriate. Where appropriate, processor 108 may include one or more arithmetic logic units (ALUs); be a multi-core processor; include one or more processors 108; or any other suitable processor.

Memory 112 may be any form of volatile or non-volatile memory including, without limitation, magnetic media, optical media, random access memory (RAM), read-only memory (ROM), flash memory, removable media, or any other suitable local or remote memory component or components. In particular embodiments, memory 112 may include random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM, or any other suitable type of RAM or memory. Memory 112 may include one or more memories 112, where appropriate. Memory 112 may store any suitable data or information utilized by computer system 100, including software embedded in a computer readable medium, and/or encoded logic incorporated in hardware or otherwise stored (e.g., firmware). In particular embodiments, memory 112 may include main memory for storing instructions for processor 108 to execute or data for processor 108 to operate on. In particular embodiments, one or more memory management units (MMUs) may reside between processor 108 and memory 112 and facilitate accesses to memory 112 requested by processor 108.

As an example, and not by way of limitation, computer system 100 may load instructions from storage 110 or another source (such as, for example, another computer system) to memory 112. Processor 108 may then load the instructions from memory 112 to an internal register or internal cache. To execute the instructions, processor 108 may retrieve the instructions from the internal register or internal cache and decode them. During or after execution of the instructions, processor 108 may write one or more results (which may be intermediate or final results) to the internal register or internal cache. Processor 108 may then write one or more of those results to memory 112. In particular embodiments, processor 108 may execute only instructions in one or more internal registers or internal caches or in memory 112 (as opposed to storage 110 or elsewhere) and may operate only on data in one or more internal registers or internal caches or in memory 112 (as opposed to storage 110 or elsewhere).

In particular embodiments, storage 110 may include mass storage for data or instructions. As an example, and not by way of limitation, storage 110 may include a hard disk drive (HDD), a floppy disk drive, flash memory, an optical disc, a magneto-optical disc, magnetic tape, or a Universal Serial Bus (USB) drive or a combination of two or more of these. Storage 110 may include removable or non-removable (or fixed) media, where appropriate. Storage 110 may be internal or external to computer system 100, where appropriate. In particular embodiments, storage 110 may be non-volatile, solid-state memory. In particular embodiments, storage 110 may include read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. Storage 110 may take any suitable physical form and may comprise any suitable number or type of storage. Storage 110 may include one or more storage control units facilitating communication between processor 108 and storage 110, where appropriate.

In particular embodiments, interface 106 may include hardware, encoded software, or both providing one or more interfaces for communication (such as, for example, packet-based communication) among any networks, any network devices, and/or any other computer systems. As an example, and not by way of limitation, communication interface 106 may include a network interface controller (NIC) or network adapter for communicating with an Ethernet or other wire-based network and/or a wireless NIC (WNIC) or wireless adapter for communicating with a wireless network.

Depending on the embodiment, interface 106 may be any type of interface suitable for any type of network for which computer system 100 is used. As an example, and not by way of limitation, computer system 100 can include (or communicate with) an ad-hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 100 can include (or communicate with) a wireless PAN (WPAN) (such as, for example, a BLUETOOTH WPAN), a WI-FI network, a WI-MAX network, an LTE network, an LTE-A network, a cellular telephone network (such as, for example, a Global System for Mobile Communications (GSM) network), or any other suitable wireless network or a combination of two or more of these, computer system 100 may include any suitable interface 106 for any one or more of these networks, where appropriate.

In some embodiments, interface 106 may include one or more interfaces for one or more I/O devices. One or more of these I/O devices may enable communication between a person and computer system 100. As an example, and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these. An I/O device may include one or more sensors. Particular embodiments may include any suitable type and/or number of I/O devices and any suitable type and/or number of interfaces 106 for them. Where appropriate, interface 106 may include one or more drivers enabling processor 108 to drive one or more of these I/O devices. Interface 106 may include one or more interfaces 106, where appropriate.

Bus 104 may include any combination of hardware, software embedded in a computer readable medium, and/or encoded logic incorporated in hardware or otherwise stored (e.g., firmware) to couple components of computer system 100 to each other. As an example and not by way of limitation, bus 104 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. Bus 104 may include any number, type, and/or configuration of buses 104, where appropriate. In particular embodiments, one or more buses 104 (which may each include an address bus and a data bus) may couple processor 108 to memory 112. Bus 104 may include one or more memory buses.

Herein, reference to a computer-readable storage medium encompasses one or more tangible computer-readable storage media possessing structures. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a flash memory card, a flash memory drive, or any other suitable tangible computer-readable storage medium or a combination of two or more of these, where appropriate.

Particular embodiments may include one or more computer-readable storage media implementing any suitable storage. In particular embodiments, a computer-readable storage medium implements one or more portions of processor 108 (such as, for example, one or more internal registers or caches), one or more portions of memory 112, one or more portions of storage 110, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody encoded software.

Herein, reference to encoded software may encompass one or more applications, bytecode, one or more computer programs, one or more executables, one or more instructions, logic, machine code, one or more scripts, or source code, and vice versa, where appropriate, that have been stored or encoded in a computer-readable storage medium. In particular embodiments, encoded software includes one or more application programming interfaces (APIs) stored or encoded in a computer-readable storage medium. Particular embodiments may use any suitable encoded software written or otherwise expressed in any suitable programming language or combination of programming languages stored or encoded in any suitable type or number of computer-readable storage media. In particular embodiments, encoded software may be expressed as source code or object code. In particular embodiments, encoded software is expressed in a higher-level programming language, such as, for example, C. Perl. or a suitable extension thereof. In particular embodiments, encoded software is expressed in a lower-level programming language, such as assembly language (or machine code). In particular embodiments, encoded software is expressed in JAVA. In particular embodiments, encoded software is expressed in Hyper Text Markup Language (HTML), Extensible Markup Language (XML), or other suitable markup language.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A wind-based power generation system comprising:
a windmill comprising:
a wheel assembly;
a gearbox coupled to the wheel assembly and configured to convert rotational motion of the wheel assembly into a reciprocal motion; and
a shaft coupled to the gearbox and driven in a reciprocal motion; and
a crank system comprising a linkage and a pitman arm, the linkage and pitman arm configured to convert the reciprocal motion of the shaft into a rotational motion.

2. The wind-based power generation system of claim 1, wherein the crank system further comprises a bracket arm configured to be coupled between the shaft and the linkage.

3. The wind-based power generation system of claim 1, further comprising a generator that is coupled to the pitman arm to transfer the rotational motion of the pitman arm to an input shaft of the generator.

4. The wind-based power generation system of claim 3, wherein the generator is a three-phase AC generator.

5. The wind-based power generation system of claim 3, wherein the generator is a DC generator.

6. The wind-based power generation system of claim 3, further comprising a battery that is electrically coupled to the generator and configured to store electrical power generated by the generator.

7. The wind-based power generation system of claim 6, further comprising a charge controller configured to control charging of the battery.

8. The wind-based power generation system of claim 7, further comprising a maximum power point tracker (MPPT) that is electrically coupled to the battery and a power grid and configured to supply power from the battery or the power grid to a load.

9. The wind-based power generation system of claim 6, further comprising an MPPT that is electrically coupled to the battery and a power grid and configured to supply power from the battery or the power grid to a load.

10. A method of generating wind-based power, the method comprising:
converting rotational motion from a wheel assembly of a windmill into a reciprocal motion;
driving a shaft using the reciprocal motion;
converting the reciprocal motion of the shaft into rotational motion:
driving an input shaft of a generator using the converted rotational motion from the shaft; and
generating electrical power via the generator.

11. The method of claim 10, further comprising storing the generated electrical power in a battery.

12. The method of claim 11, further comprising providing electrical power from the battery to a load.

13. The method of claim 10, wherein the converting the reciprocal motion of the shaft into rotational motion comprises using a crank system, the crank system comprising:
a bracket arm connected to the shaft;
a linkage connected to the bracket arm; and
a pitman arm connected to the linkage.

14. A wind-based power generation system comprising:
a controller configured to control the storage and usage of electrical energy generated by a generator driven by wind; and
logic, stored on non-transitory, computer-medium, that, upon execution by one or more processors, causes performance of operations including:
responsive to a determination that a power grid is not supplying power to a load, discharging a battery to provide power to the load; and
responsive to a determination that the power grid is supplying power to the load, further determining if it is within a peak time and supply power to the load from the battery if it is within a peak power time.

15. The wind-based power generation system of claim 14, wherein the logic is further configured to limit charging of the battery to 90% of a maximum capacity of the battery.

16. The wind-based power generation system of claim 14, wherein the logic is further configured to limit discharging of the battery to 10% of a minimum capacity of the battery.

17. The wind-based power generation system of claim 14, wherein the logic is further configured to monitor a charge status of the battery to maintain the battery at 90% of a maximum capacity of the battery outside of a peak power time.
